(19) United States
(12) Patent Application Publication
(10) Pub. No.: US 2008/0066005 A1
(43) Pub. Date: Mar. 13, 2008

(54) Systems and Methods of Interfacing with Enterprise Resource Planning Systems

(76) Inventor: David McMullen, Orlando, FL (US)

Correspondence Address: WELSH & KATZ, LTD, 120 S RIVERSIDE PLAZA, 22ND FLOOR, CHICAGO, IL, 60606, US

(21) Appl. No.: 11/847,492

(22) Filed: Aug. 30, 2007

Related U.S. Application Data
(60) Provisional application No. 60/824,809, filed on Sep. 7, 2006.

(51) Int. Cl. G06F 3/048

(52) U.S. Cl. 715/771

(57) ABSTRACT

A user friendly graphical interface responds to a user designated Business Application Programming Interface (BAPI) of an enterprise resource planning system by presenting classes of information from the designated BAPI. The interface enables the user to review or edit parameters or data associated with the designated BAPI in a graphical format. The edited information can be returned to the BAPI which can then be executed. The user can then review results form the executed BAPI.

### CROSS-REFERENCE TO RELATED APPLICATION

This application claims the benefit of the filing date of U.S. Provisional Application Ser. No. 60/824,809 filed Sep. 7, 2006 and entitled “Analysis Tool for Application Programmers”.

### FIELD

The invention pertains to systems and methods of interacting with enterprise resource planning systems. More particularly, the invention pertains to user friendly interfaces and methods which facilitate evaluation and testing operation of business application planning interfaces found in such planning systems.

### BACKGROUND

Enterprise Resource Planning (ERP) systems offered by various companies including IFS, SAP, Microsoft and Oracle provide generic business process interfaces and forms which provide a raw data view. ERP interfaces are expert friendly requiring extensive training and experience for the user to form the mental bridge between their work domain and the synthetic domain provided by the respective ERP system.

Many customers require simplified user interfaces, presented in their native domain context to provide ease of use. For example, SAP R3-type systems are very complex and are usually accessed programmatically through a Java Connector (JCO) and Business Application Programming or Process Interfaces (BAPI).

A programmer can sometimes determine which BAPIs relate to which forms in a given SAP system but there exist no tools or methods to experiment with BAPIs to determine the cause and effect of passing different parameter content thereby resulting in the data being returned.

The structure of BAPIs can be quite complicated. Attempting to call a BAPI simply to find out what will be returned requires advanced knowledge of the specific BAPI structure. Many times the calls and time spent creating the calling code are completely fruitless.

There is a need to simplify user interactions with BAPI-type interfaces. It would be especially useful to be able to experiment by modifying and then executing or testing the modified BAPI to evaluate the results of such modification.

### BRIEF DESCRIPTION OF THE DRAWINGS

FIG. 1 is an overall diagram of a system which embodies the present invention;

FIG. 2 illustrates an initial screen presented to a user of the present BAPI edit/test software;

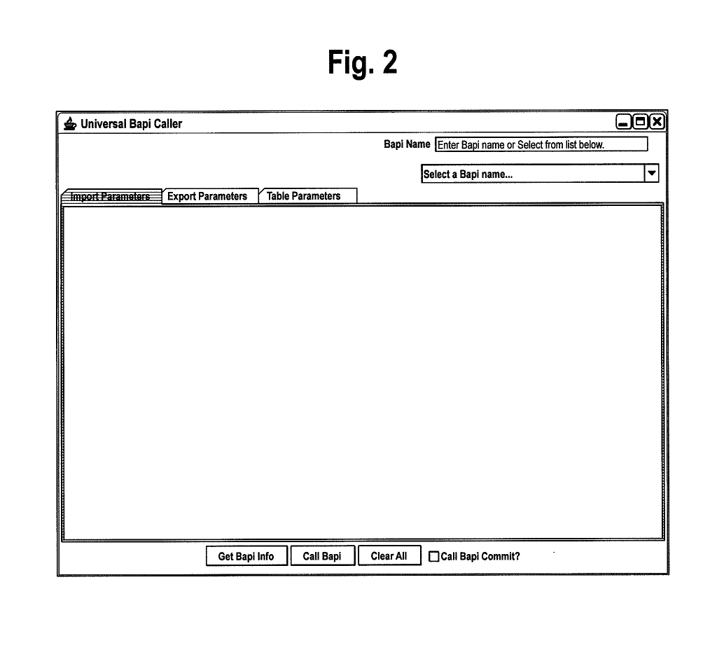

FIG. 3 is a screen presented to a user of import parameters for a specified BAPI;

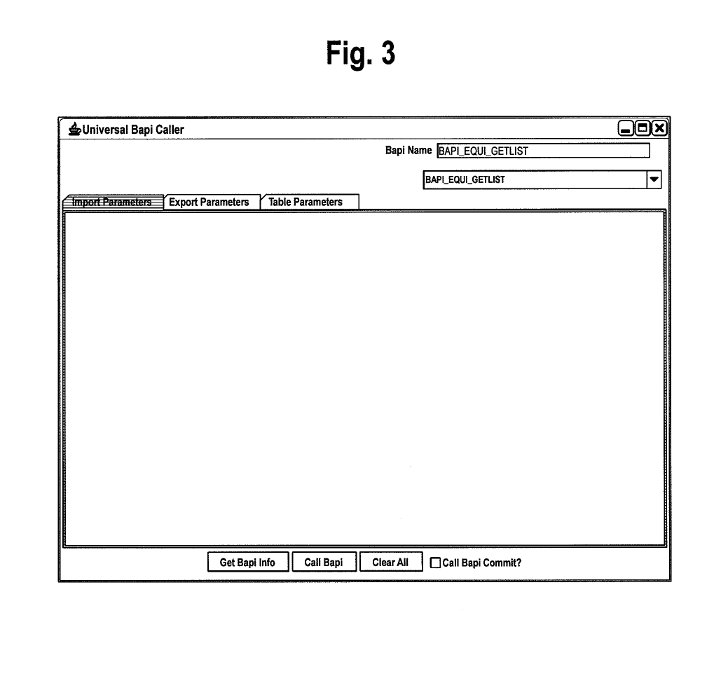

FIG. 4 is an exemplary screen presented to a user of export parameters of a specified BAPI;

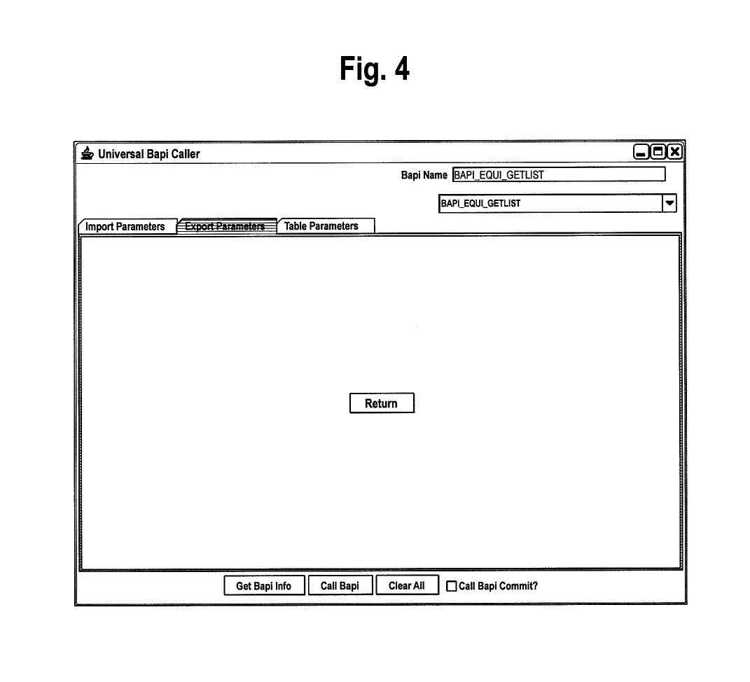

FIG. 5 is a screen presented to user illustrating a returned export parameter information for the specified BAPI;

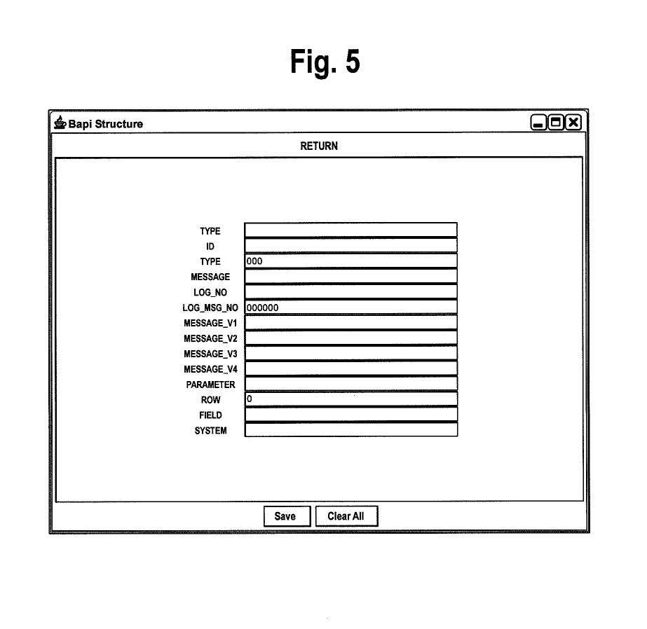

FIG. 6 is a screen illustrating returned table parameters for the specified BAPI;

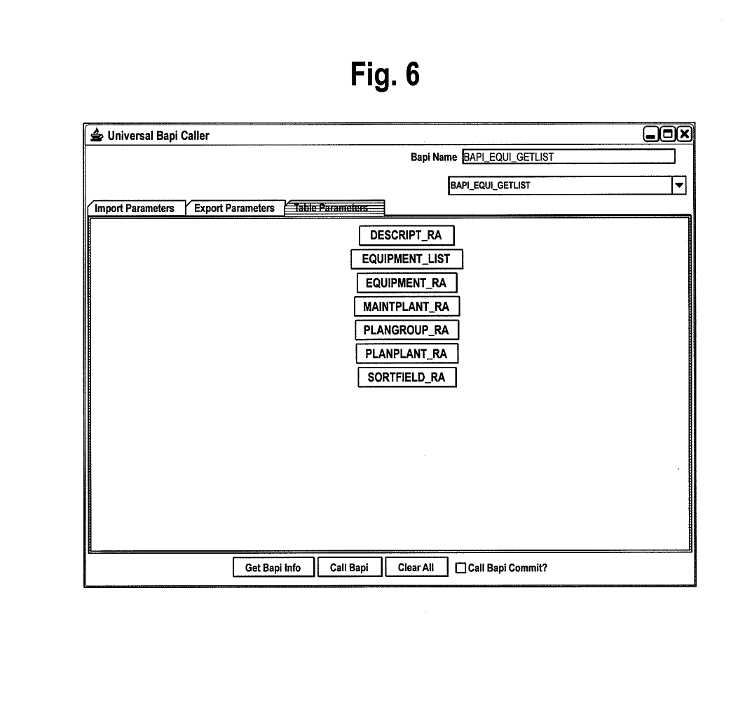

FIG. 7 is a screen illustrating a selected table from the screen of FIG. 6;

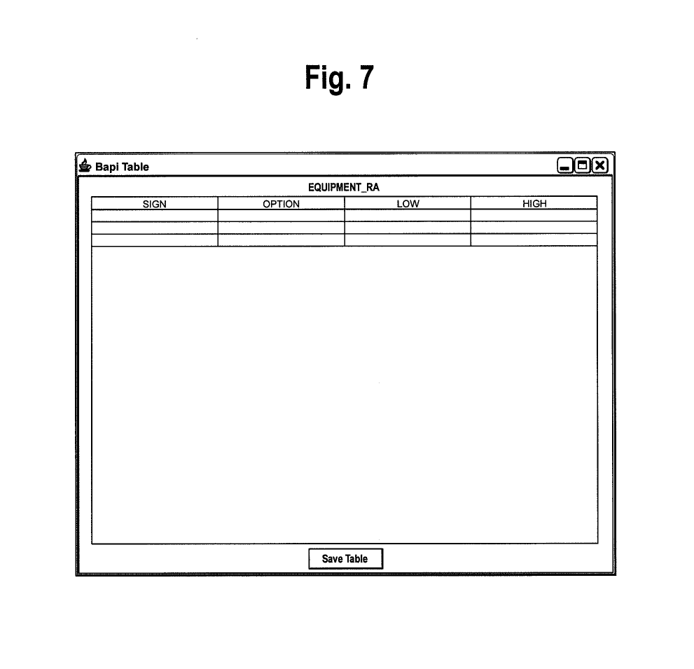

FIG. 8 is a screen illustrating user data entered into the table of FIG. 7 specifying equipment;

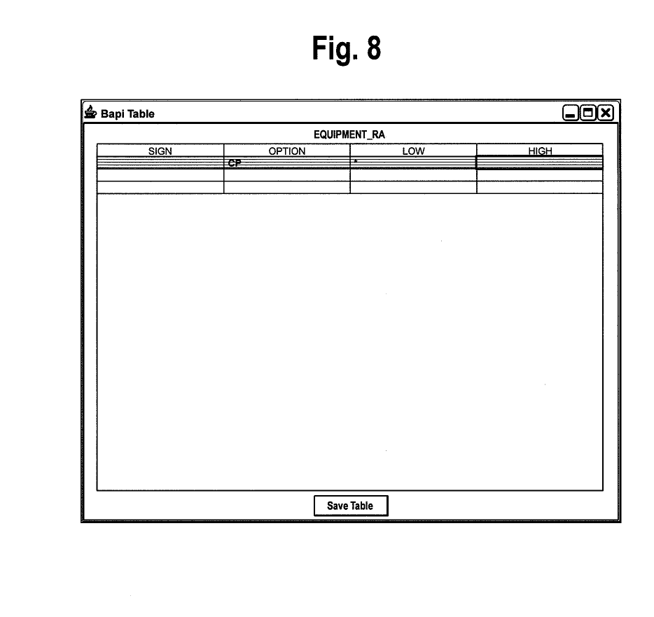

FIG. 9 illustrates exemplary returned table information in accordance with the specification of FIG. 8;

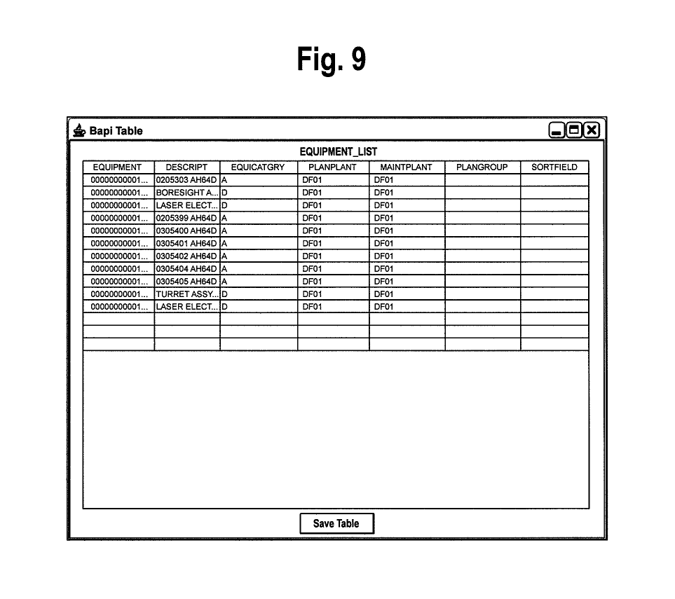

FIG. 10 is a flow diagram of a process of developing a new BAPI;

FIG. 11 is a flow diagram illustrating a BAPI query process; and

FIG. 12 is a flow diagram illustrating sending an updated BAPI to the associated enterprise planning system product.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with this invention, a JAVA Swing application can be built around the SAP JCO libraries for use with SAP ERP systems. It provides the functionality of the JCO libraries without requiring a user to write the specific implementation code.

Because much the implementation code is similar with only specific field names, table names and such being changed, it is possible to extract those details and use them where necessary. Given only a BAPI name, systems and methods which embody the invention extract the BAPI structure and display textboxes, buttons, and tables to correlate directly with the BAPI structure.

Using such systems and methods makes research on whether or not a specific BAPI is useful for the current requirement much less time consuming, and provides a simple graphical model of a BAPI for explaining the general structure of a BAPI, or the details of a specific BAPI. Embodiments of the present invention can be implemented for use with ERP-type systems marketed by IFS, Microsoft and Oracle all without limitation.

Developers can use tools or interfaces which embody the invention to quickly analyze a BAPI, and attempt test calls to determine its value if used in a current project. It minimizes any need for the developer to write “throw away code” simply to perform these same tests and evaluation. Hence, they should be very useful to an entity that wants to provide an abstracted user interface to an ERP system.

It will be understood that the present invention is not limited to SAP products or systems such as SAP R3-type products and systems. The present methods and systems are applicable to Enterprise Resource Planning systems irrespective of origin.

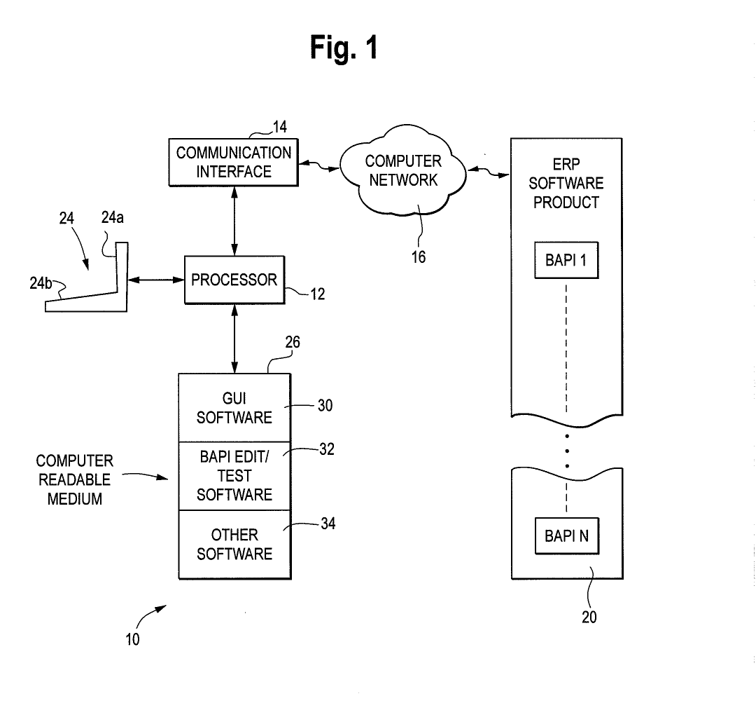

FIG. 1 illustrates a system 10 which embodies the present invention. System 10 incorporates a programmable processor 12 which, for example, could be incorporated into a personal computer, a computer workstation or the like all without limitation. Processor 12 has coupled thereto a communication interface 14 which enables processor 12 to communicate via one or more computer networks 16, which could be implemented for example via the Internet, with one or more enterprise resource planning software products 20.

Programmable processor 12 has coupled thereto at least input output device 24 for a user. Device 24 can include a multi-dimensional graphical display 24a and a manually operable input device such as a keyboard 24b.

Processor 12 executes a variety of system and application programs as would be understood by those of skill in the art. All such programs could for example be stored on a computer readable medium such as medium 26.

Medium 26 could be implemented in read/write storage units, programmable read-only storage units, mass storage units such as magnetic disk drives and/or optical disk drives all without limitation. Representative software which could be carried on computer readable medium 26 includes graphical user's interface software 30 of the type usable to present displays on unit 24a and receive information from keyboard 24b.

The computer readable medium 20 can also carry BAPI/test software 32 as described in more detail subsequently. Additional software including operating system software and the like 34 could also be carried on the medium 26.

The enterprise software product 20 can include a plurality of interfaces indicated as BAPI 1—BAPI and all without limitation. Such interfaces can be used by the software products to provide external access to data and processes of the enterprise system. Such enterprise resource planning software products are known from prior art, as noted above in the Background section hereof, and would be understood by those of skill in the art and do not need to be discussed further.

BAPI edit/test software 32 provides an easy to use facility to review, edit and then test the operation of edited interfaces such as BAPI i from the software product 20. As explained below, a user can call a selected existing BAPI from the system 20, review its contents, edit same and then cause the software product 20 to execute the edited BAPI for purposes of evaluation of the results thereof. Where the results are satisfactory, the user can then arrange to create a counterpart to the modified BAPI and install same on the system 20 for subsequent use.

In one aspect of the invention; a tool is provided that implements testing of BAPIs. The tool can be implemented as a java swing application, built on the SAP Java Connector (JCo). It abstracts the java coding necessary to call a BAPI into a simple and understandable user interface. Advantageously, if a BAPI call turns out to be fruitless, the developer didn't waist time writing java code for that specific BAPI.

The following example illustrates how to create and test a new BAPI, namely, Get List of Equipment

BAPI: BAPI_EQUI_GETLIST

Run the UBC tool. The following image displays the main screen of the application.

The “BAPI Name” textbox is where the BAPI name would be entered. The application also stores previously used BAPIs, and are listed in the drop down list box. Any previously used BAPIs can be selected to keep the user from typing in the full name, and memorizing them.

In the center area of the application are three tabs; import parameters, export parameters, and table parameters. If these do not sound some what familiar at this point, I would suggest reading the BAPI appendix to become more familiar with the structure of BAPIs.

Type in the BAPI Name textbox: “BAPI_EQUI_GETLIST”, or find it in the list if it has already been used. At the bottom of the application, there are three buttons, click the button that says “Get BAPI Info”. For a high level description of what this does, it magically gets all the information about the BAPI entered, and displays the three types of parameters in the three tabs. Click the other tabs to see what was created. They should look like the following.

Notice that the import parameter tab is empty, that's because for this BAPI there are no import parameters. On the export tab, there is a button called Return. A button on the import or export parameter tabs represents a BAPI structure. Click the button to see the Return structure for this BAPI.

A new window pops up, and displays the return structure. Notice that these are name value pairs with textboxes. This is how information in a structure would be edited. The save button will save the data entered into the actual BAPI structure in the BAPI. For this particular structure, the data will be returned from SAP, not sent in, so editing it would be useless. Click the red ‘X’ to close this window and go back to the main page.

The Table tab displays BAPI tables for this particular BAPI. They are represented as buttons. To get the equipment list from SAP, we need to send in some search criteria, and these tables are how to do it. Click the “EQUIPMENT_RA” button, this stands for equipment range. The table will pop up in a new window, similar to the BAPI structure.

Now that the table is open and ready for editing, enter the following values for the search criteria:

SIGN: I

OPTION: CP

LOW: *

The ‘I’ for sign means include, the ‘CP’ for option means contains pattern, and the ‘*’ for low is the range of values we want. A star means all values. So the table should look like the following:

Now click the save button, and the data will be saved in the BAPI, and the window will close. Now that all the data needed for the BAPI is entered, all that's left is to call the BAPI and see the results. On the main display screen, at the bottom is a button that says “Call BAPI” on it. Click it. This process may take a little time, depending on the magnitude of what the BAPI is supposed to do. When it is complete, the application will jump to the “Export Parameters” tab.

Click the return structure to view what SAP sent back. Unfortunately, this particular BAPI returns nothing, if it was successful, so seeing the same information as before isn't necessarily a bad sign. Checking the return is a good way to find out what is missing in a BAPI call if it was unsuccessful.

Go to the Table Parameter tab and click the “EQUIPMENT_LIST” button. This table will hold the results from this BAPI call. My call resulted in the following, but the results depend on the data in the database.

That's the entire process of calling a BAPI with the UBC.

Call BAPI Commit?

The call BAPI commit check box at the bottom of the main page is used to signal, that after the current BAPI call executes call the commit BAPI as well. Some BAPIS require that, after calling the BAPI, with the same connection the “BAPI_TRANSACTION_COMMIT” BAPI must be called to save the results.

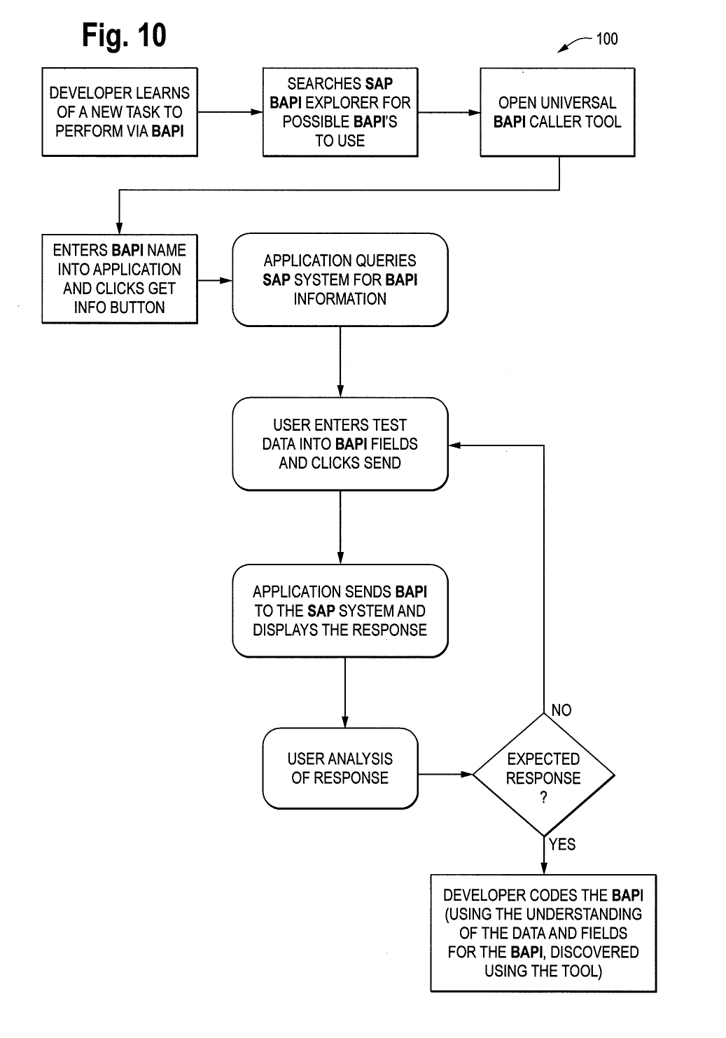

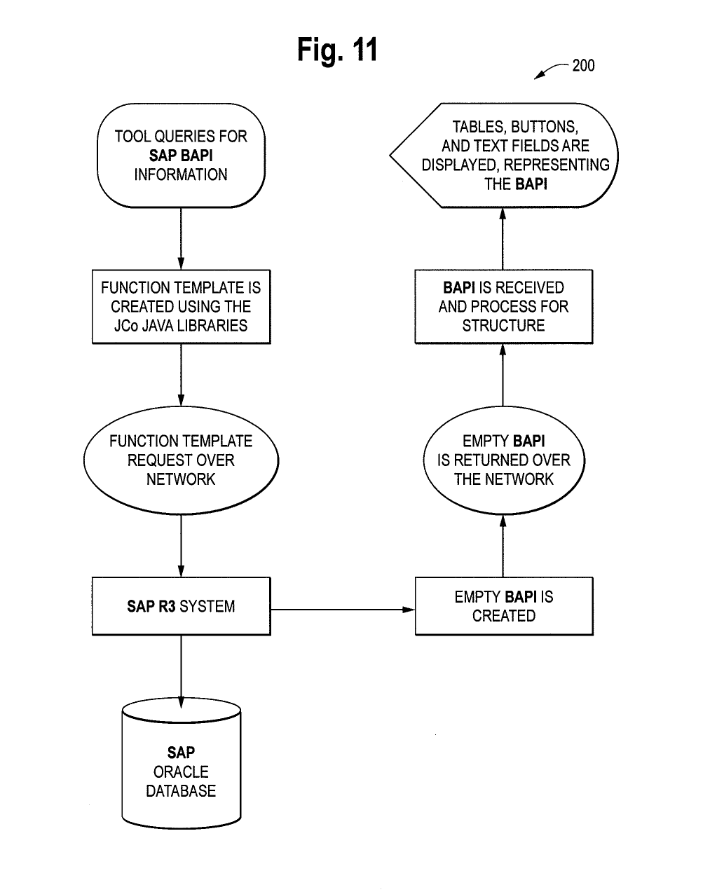

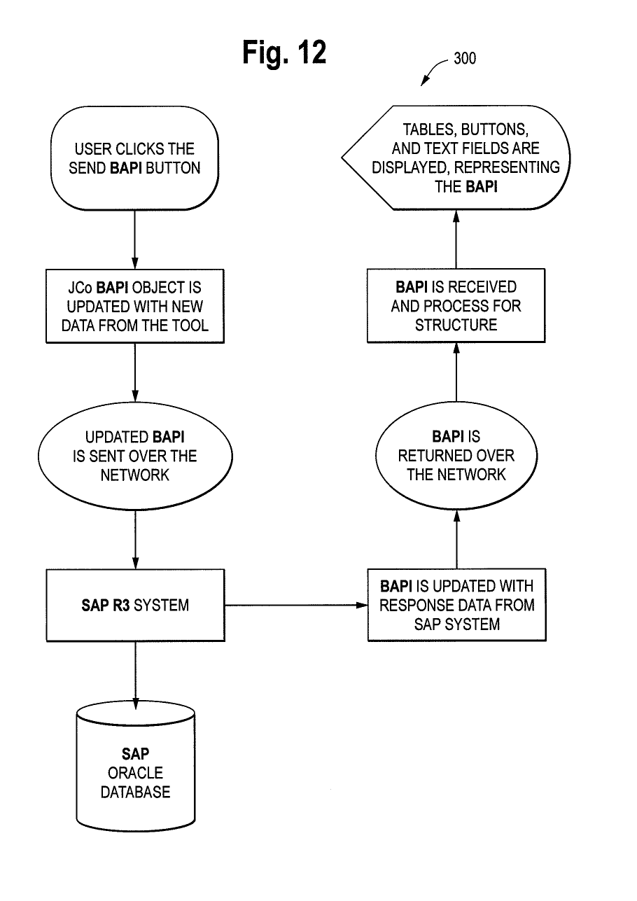

FIGS. 10-12 are flow diagrams that illustrate a method that embodies the invention. FIG. 10 illustrates an over-all method or process 100 of using a tool or interface in accordance with the invention. FIG. 11 illustrates a process 200 of returning an empty BAPI in response to a user inquiry. FIG. 12 illustrates processing 300 of an updated BAPI which has been loaded with information and data using the present tool or interface. Response data from the system is provided to the user.

Embodiments of the invention can be implemented in digital electronic circuitry, or in computer hardware, firmware, software, or in combinations of them. The embodiments can also be implemented in a computer program product tangibly embodied in a computer readable storage device for execution by a programmable processor. Method steps of embodiments of the invention can be performed by a programmable processor executing a program of instructions to perform specified functions by operating on input data and generating output.

Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language or, in assembly or machine language, if desired; and in any case, the language can be a compiled or interpreted language.

Suitable processors include, by way of example, both general and special purpose microprocessors. In some implementations, a processor will receive instructions and data from a read-only memory and/or a random access memory.

A computer with a programmable processor can include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method of evaluating a business application programming interface associated with an enterprise resource planning system comprising:
identifying a business application programming interface, which is coupled to an enterprise resource planning system;
requesting multi-class information relative to the identified interface;
selecting a class of returned information;
responsive to the selected class, presenting visually the returned information;
editing the returned information; and
saving the edited information in the identified interface.

2. A method as in claim 1 selecting from among import parameters, export parameters and table parameters.

3. A method as in claim 2 where editing includes editing at least one of import parameters, or table parameters.

4. A method as in claim 2 which includes selecting table parameters and presenting a plurality of table names for the selected business application planning interface.

5. A method as in claim 4 which includes selecting a table from the plurality and editing same.

6. A method as in claim 5 which includes saving the edited table.

7. A method as in claim 1 which includes executing the identified interface.

8. A method as in claim 6 which includes executing the identified interface.

9. A method as in claim 8 which includes presenting results of executing the identified interface.

10. A computer readable medium including computer executable instructions for evaluating a business application programming interface associated with an enterprise resource planning system, the computer executable instructions implementing,
identifying a business application programming interface, which is coupled to an enterprise resource planning system;
requesting multi-class information relative to the identified interface;
selecting a class of returned information;
responsive to the selected class, presenting visually the returned information;
editing the returned information; and
saving the edited information in the identified interface.

11. An apparatus comprising:
at least one programmable processor coupled to,
a communications link to an enterprise resource planning system, the enterprise system including a plurality of application specifiable executable interfaces; and
a graphically based editor and test module, executable by the at least one processor, the module implements:
identifying a business application programming interface, which is coupled to an enterprise resource planning system;
requesting multi-class information relative to the identified interface;
selecting a class of returned information;
responsive to the selected class, presenting visually the returned information;
editing the returned information; and
saving the edited information in the identified interface.

12. An apparatus as in claim 11 which includes software to program an interface.

13. A method of developing an application programming interface for an enterprise resource planning system comprising:
selecting at least one interface from a plurality of existing interfaces;
obtaining information and parameters for the selected interface from the resource system;
entering test data into the selected interface thereby forming a test interface;
sending the test interface to the resource system and executing same;
evaluating the result from executing the test interfaces;
responsive to the evaluation, modifying the test interface and executing the modified test interface; and
responsive to execution of the modified test interface, where the results
conform to predetermined requirements, creating a corresponding programming interface.

14. A method as in claim 13 which includes storing the created programming interface.

15. A method as in claim 13 where obtaining includes:
creating a function template;
transmitting a request, based on the template to the resource system;
creating a representation of the selected interface; and
generating a displayable and a user's editable form of the selected interface.

16. A method as in claim 13 where sending and executing include:
transmitting the test interface to the resource system via a communications network;
retrieving prestored information from at least one resource system data base;
updating the test interface in accordance with the prestored information;
returning the updated interface via the communications network; and
creating a displayable and user editable version of the updated interface.

17. An apparatus comprising:
executable interface software carried on a computer readable medium comprising:
user responsive software that receives a business application process interface name;
processing software that extracts structural information from a named interface; and
display software that visually presents to the user indicia based on at least some of that structural information.

18. An apparatus as in claim 17 which includes software that enables a user to edit the displayed indicia.

19. An apparatus as in claim 18 which includes a programmable processor that executes the interface software and circuitry coupled to an enterprise resource planning system, where the edited indicia are transmitted to the resource system for execution.
